(19) United States
(12) Patent Application Publication
(10) Pub. No.: US 2025/0139063 A1
(43) Pub. Date: May 1, 2025

(54) DYNAMIC DATA ENVIRONMENT AND COMPUTATIONAL ENVIRONMENT CREATION FOR REAL-TIME MACHINE LEARNING AND REQUEST PROCESSING

(71) Applicant: FENNEL AI, INC., Palo Alto, CA (US)

(72) Inventors: Nikhil Garg, San Mateo, CA (US); Abhay Kumar Bothra, Fremont, CA (US); Aditya Nambiar, Fremont, CA (US); Jollu Mohit Reddy, Mountain View, CA (US)

(21) Appl. No.: 18/500,073

(22) Filed: Nov. 1, 2023

(51) Int. Cl. G06F 16/21

(52) U.S. Cl. CPC G06F 16/211

(57) ABSTRACT

Methods, systems, and apparatus, including computer programs encoded on computer storage media relate to a method for creating a data environment and a computational environment to perform data processing and real-time data request management. The system provides for the creation of definition files to create a data environment to periodically precompute aggregated data values, and the creation of an execution environment in which features may be defined to process a real-time request with at least one of the features accessing one of the created datasets.

### FIELD OF INVENTION

Various embodiments relate generally to feature engineering, and more particularly to dynamic data environment and computational environment creation for real-time machine learning and request processing.

### SUMMARY

Methods, systems, and apparatus, including computer programs encoded on computer storage media relate to a method for creating a data environment and a computational environment to perform real-time machine learning processing and real-time (i.e., live) request processing. The system provides for the creation of definition files to create a data environment to periodically precompute aggregated data values, and the creation of an execution environment in which features may be defined to process real-time requests with at least one of the features accessing one of the created datasets. Additionally, the execution environment may be configured to perform real-time machine learning processing.

In some embodiments, the system performs multiple operations to create and operate a data environment and a computational environment to perform data processing and real-time data request management. The system may be configured to define features that interact and process data with one or more machine learning models, artificial intelligence service and/or machine learning service or systems.

In some embodiments, the system may define, create and/or operate a data environment. For example, the system may receive one or more dataset connector definition files, where the dataset connector definition file describes a data source. The system may receive one or more dataset definition mapping files, where the dataset definition mapping files, describes or identifies fields of the data source. The system may receive one or more feature set definition files, where the feature set definition files describe one or more of computation and aggregation of data values associated with the defined fields of the data source. The system may periodically create one or more data instances based on the dataset connector definition, the dataset definition mapping, and the feature set definition files. The datasets that are created include aggregated data values and/or computed data values from fields of the data source.

In some embodiments, the system may receive one or more feature definitions files to perform one or more predefined functions. The system may create, based on the one or more feature definition files, one or more computation unit instances in memory based on a received computation unit definition. One or more of the computational unit instances provides for read or lookup functions as to the aggregated data values and/or computed data values from the periodically created datasets. The feature definition files may be written in code (such as Python code) and the code is evaluated and translated into machine code that is stored in memory for fast (non-interpreted code) operations.

In some embodiments, after the data environment and the computational environment are created, the system may receive real-time requests from other systems or applications. For example, the system may receive a real-time request comprising a data input to perform an operation where the endpoint of feature definition file describes the input requirements for the endpoint. The endpoint, for example, may be configured as an application programming interface to receive calls from other systems.

In some embodiments, based on the received real-time request, the system performs one or more operations by one or more of the computation units, where at least one of the one or more computation units performs a data operation on the created data instances. For example, one of the feature definition files includes a reference to one of the aggregated data values of the periodically created dataset.

Furthermore, the appended claims may serve as a summary of this application.

### BRIEF DESCRIPTION OF THE DRAWINGS

The present invention relates generally to creating a data environment and a computational environment that receives data from the data environment.

The present disclosure will become better understood from the detailed description and the drawings, wherein:

FIG. 1 illustrates an example data and computational environment configuration according to example embodiments;

FIG. 2A illustrates example code of a dataset and defining data sources according to example embodiments;

FIG. 2B illustrates example code defining datasets integrated with data sources according to example embodiments;

FIG. 2C illustrates example code of a data pipeline configuration according to example embodiments;

FIG. 2D illustrates example code of a dataset lookup operation and a feature set according to example embodiments;

FIG. 2E illustrates example code of a synchronization call procedure according to example embodiments;

FIG. 3A illustrates a flow diagram of an example process according to example embodiments;

FIG. 3B illustrates a flow diagram of an example process according to example embodiments; and

FIG. 4 is a diagram illustrating an exemplary computer that may perform processing in some embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer readable storage medium and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable media or a non-transitory computer readable storage medium.

The instant features, structures, or characteristics described in this specification may be combined in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one example. Thus, appearances of the phrases “example embodiments”, “in some embodiments”, “in other embodiments,” or other similar language, throughout this specification can all refer to the same embodiment. Thus, these embodiments may work in conjunction with any of the other embodiments, may not be functionally separate, and the described features, structures, or characteristics may be combined in any suitable manner in one or more embodiments.

Example embodiments provide methods, systems, hardware components, non-transitory computer readable media, devices, and/or networks, which provide a client device, server and/or a client/server model for a particular data and computational environment. The environment may be managed by an environment application used for various data processing operations, such as machine learning data processing. In an example utilizing a client device, a client application may be used to define certain features, which are then synchronized with the server. The client application may be based on PYTHON software code or other example software programming languages known to those skilled in the art. In operation, the server may be responsible for computing, storing, and serving features.

In some embodiments, the system receives definition files via a client application. The client application provides functionality to receive the definition files and transmit the definition files to a system server. These definition files collectively define an operable system where the system provides specified operations and provides for the creation of data instances of pre-aggregated and/or pre-computed data values. The client application synchronizes the definition files to a server where the server creates a data environment and a computational environment based on the definition files. For example, the server receives definition files for one or more of a plurality of dataset connector definition files, a plurality of dataset definition files, a plurality of feature set definition files and a plurality of feature definition files. Collectively, the server creates an environment based on these received definition files. In some instances, the definition files are individual files including the respective definitions. In some instances, the definition files may be multiple definition files combined into a single file.

In some embodiments, the system requires that the definition files include a version number (e.g., an alpha-number text string) to identify which of the definition files correspond to a system version. After receiving the definition files, the system evaluates each of the received definition files to verify versioning evolution of all components individually, and verifies that the last version of each component works with the latest version of other components. If any one of the definition files does not have the same version number of the other definition files, the system generates error information and does not create the data environment and/or the computational environment.

In some embodiments, after the initial data environment and computational environment are created by the system, the client application may transmit to the server, one or more updated, modified or new definition files. The system may have stored on a storage device the original definition files corresponding to the initial data environment and the computational environment. The definition files may include an identifier and a version number that uniquely describes a system and system version for the data environment and the computational environment. The system may make changes to the initial data environment and/or the computational environment based on the received one or more updated, modified or new definition files. For example, the client application may transmit to the server an updated feature definition file changing the functions of a particular feature. The system would then update the computational environment to with the changes in the updated feature definition file.

In some embodiments, the system performs a validation process on the received definition files. If the received definition files do not pass the validation process, then the system does not create the data environment and/or the computational environment. For example, the system may generate a data flow graph to evaluate the data flow of the data source to the data instances. The system determines whether the data flow graph is valid. In other words, the system determines that the data source and connections are valid. If the system determines that the data flow graph is not valid, then the system generates an error message about the definition files for the data environment and describes the identified problem with the definition files.

In some embodiments, the system validates the definition files by determining whether dependencies described in the definition files are valid. For example, if any construct depends on something else (e.g., a pipeline takes another dataset as an input), the system validates that all such dependencies are available. The provides for the control that any construct cannot be deleted until the constructs upon which it depends have been deleted first. If the system determines that a dependency issue exists, then the system generates an error message about the dependency issue for the definition files describing the identified problem.

In some embodiments, the system validates the definition files to determine invalid field/type relationships. For example, the system matches data types across dependencies to detect invalid relationships. If a dataset has a field of a certain type, but the pipeline that produces that dataset does not use the same filed/type, the system will identify the error. If the system determines that a field/type relationship issue exists, then the system generates an error message about the filed/type relationship issue for the definition files describing the identified problem.

In some embodiments, the system validates the definition files to determine circular dependencies in dataflow during synchronization of the data. If the system determines that a circular dependency issue exists, then the system generates an error message about the circular dependency issue for the definitional files describing the identified problem.

In some embodiments, the client application transmits the complete definition files to a system server. The system translates some or all of the definitional files into an Abstract Syntax Tree (AST) of the code of the definitional file. The AST is a representation of the abstract syntactic structure of text of the definitional file. For example, the feature definition files may include code written in Python. In some embodiments, the system uses the AST in the computational environment to process functions of the defined features. In some embodiments, the system uses AST and actual portions of Python code that have been defined in the feature definition files.

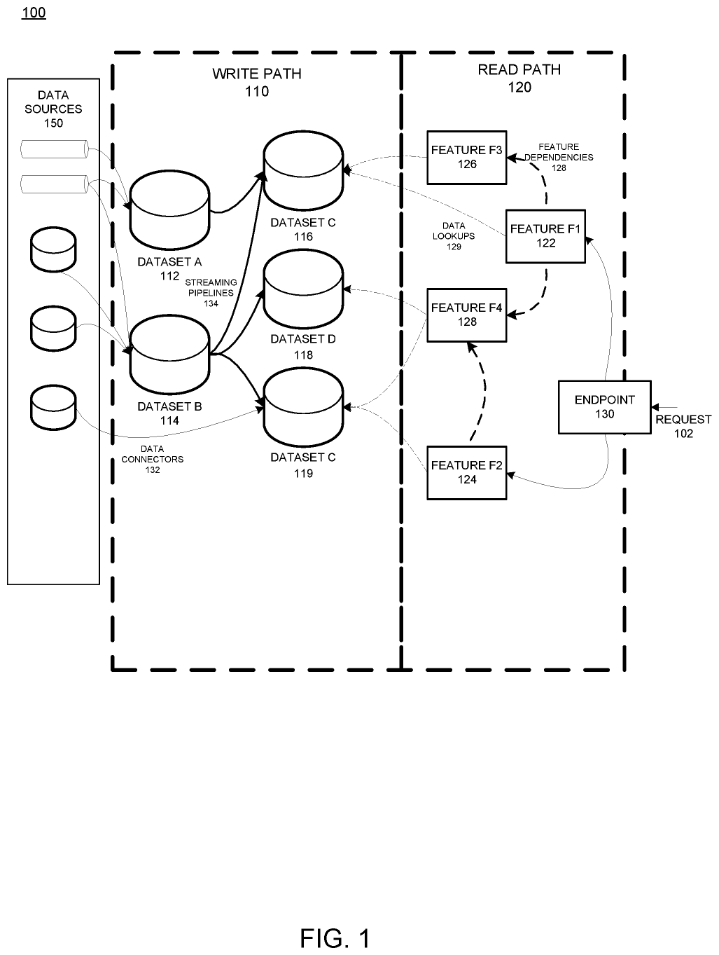

FIG. 1 illustrates an example data environment and computational environment configuration according to example embodiments generated by the system. Referring to FIG. 1, the system environment 100 includes two paths including the write path 110 (i.e., the data environment) and the read path 120 (i.e., the computational environment), which are denoted as separate environments which are used together to satisfy data resources. The data sources 150 may provide data which is dynamically forwarded to the write path 110 to create one or more datasets 112, 114 which are then used to generate and/or populate additional datasets 116, 118 and 119. Data connectors 132 provide the basis for updated information and definitions which are used to create new datasets and/or update existing datasets. The datasets may use streaming data pipelines 134 (denoted by the bold line) to forward data to the various datasets and to create relationships between the datasets. The read path 120 includes various features 122, 124, 126 and 128 which can be used to form feature sets. The data lookups 129 (see patterned lines) may be invoked by the features 122-128, which are based on a received request 102 from the endpoint (REST API) 130. The request may identify specific data values which are needed to satisfy a query for updated information.

Datasets 112-119 may represent structured data sources which include tables that can be used for feature pipelines 134. The datasets are constantly being updated as new data arrives from connectors associated with various data sources. Datasets 112-119 may be derived from defined pipelines 134 that transform data across different sources (e.g., AMAZON simple storage service (S3), APACHE KAFKA, POSTRGRESQL ‘postgres’, etc.) in a same plane of abstraction. For example a data source may be a database or other system, file system, service or application that stores and manages data. The pipelines 134 may be declarative and PYTHON native and may also provide data in real-time.

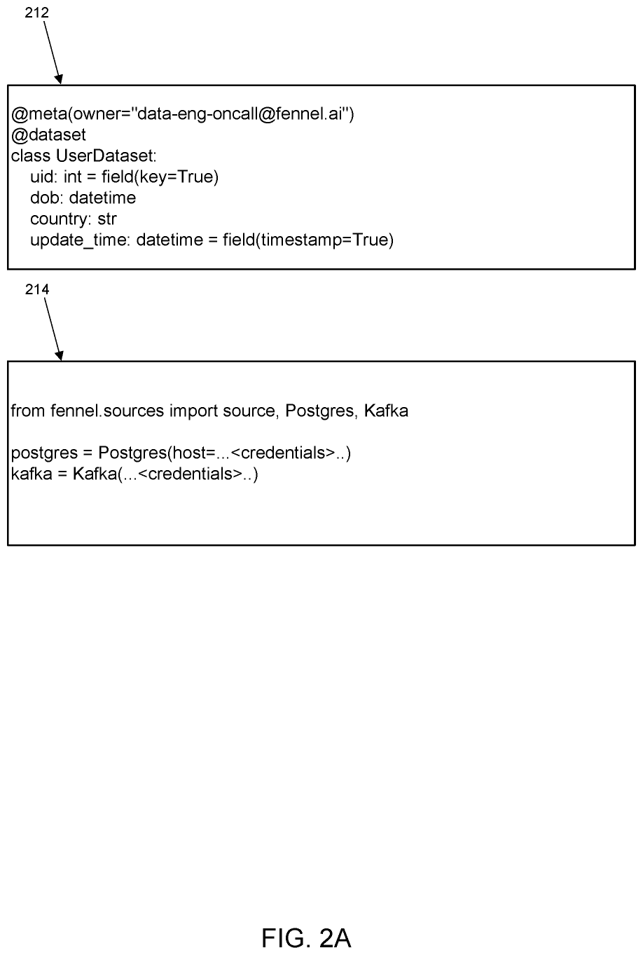

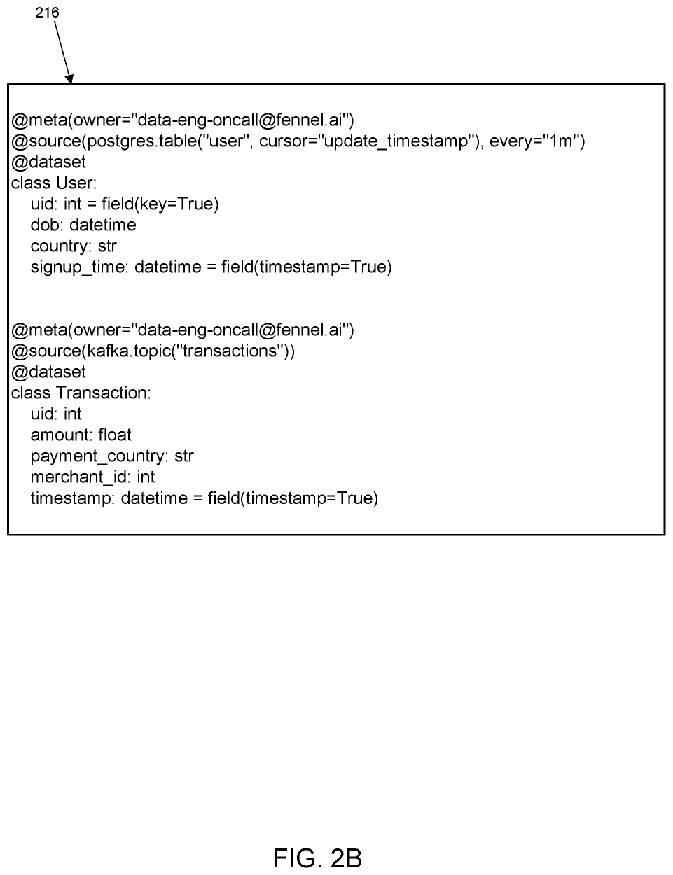

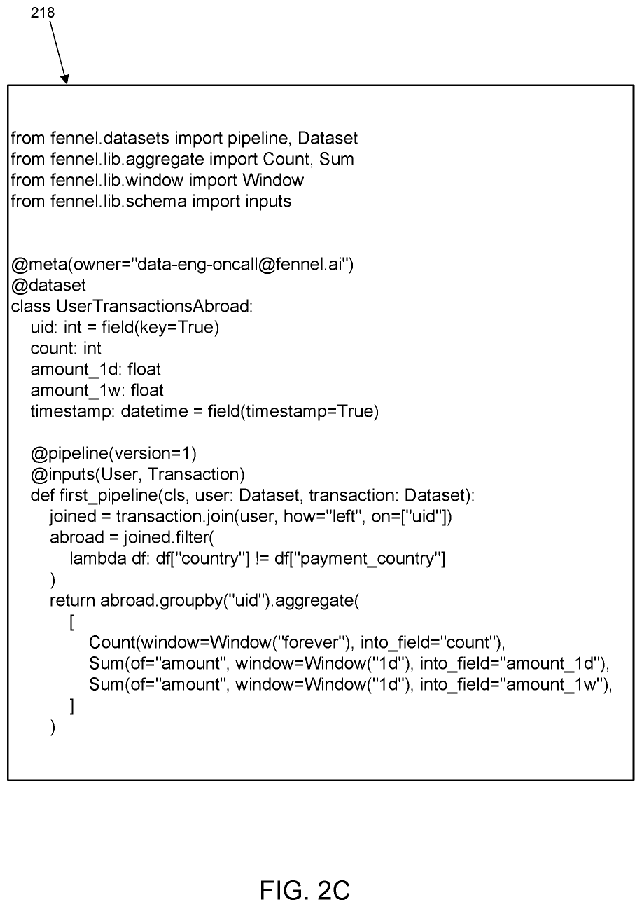

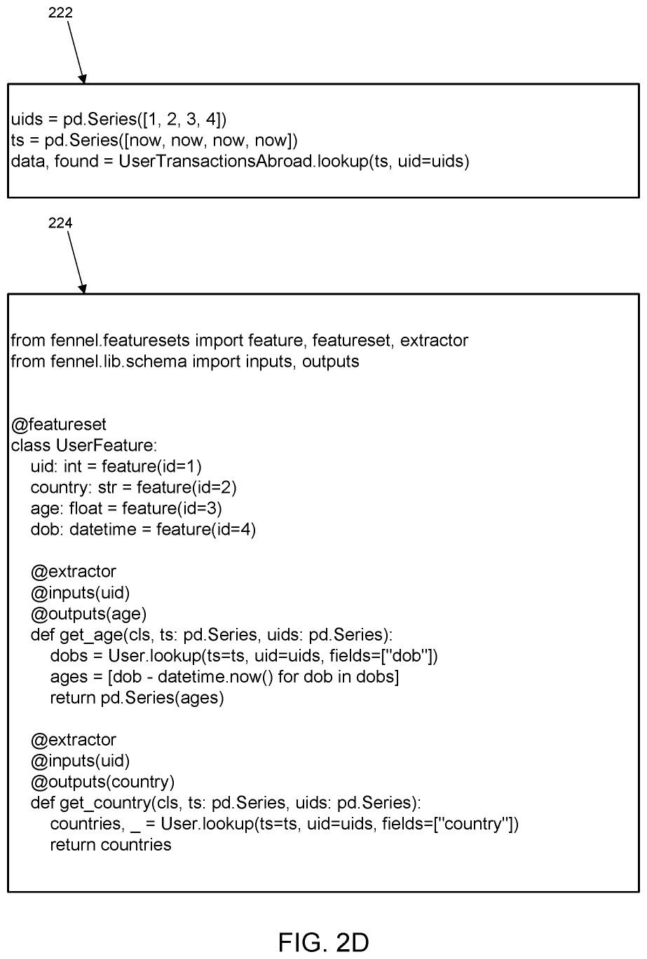

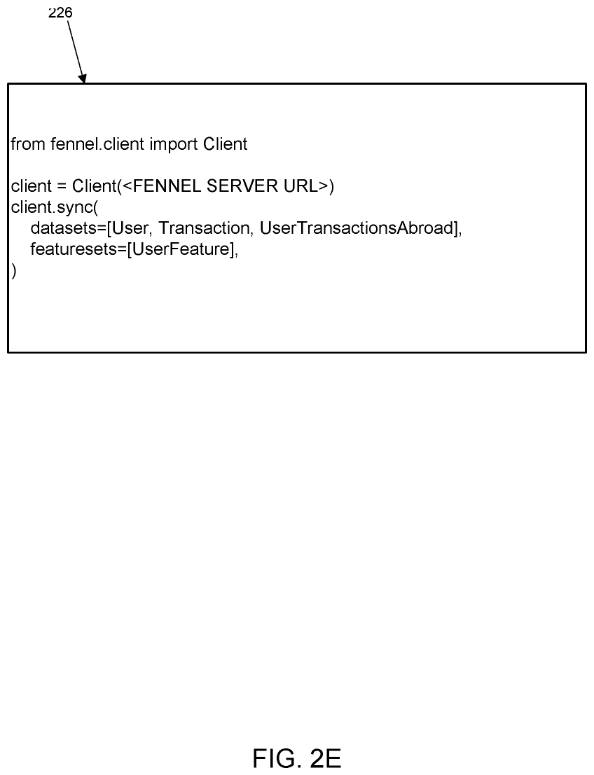

FIG. 2A illustrates example code of a dataset and defining data sources according to example embodiments. Referring to FIG. 2A, the dataset code 212 demonstrates the class of data which includes various data values (e.g., UID, dob, country, time) that define the dataset. The data sources which provide the data may be identified 214 by specifically identified sources which can import data to the dataset periodically for specific data values identified in structured and/or unstructured data formats.

Feature sets are containers for the ‘features’ that may be extracted from the datasets. Features, unlike datasets, have no state and are computed on a ‘read path’ (i.e., when queried). Features are immutable to improve reliability. Once datasets/feature sets have been written or updated, the definitions can be synchronized with the server by instantiating a client to communicate with server. The read path may be queried for real-time features (i.e., features using the latest value of all datasets). Query requests can be made over a REST API (endpoint 130) from any language/tool which enables features to be provided to a server.

FIG. 2B illustrates example code defining data sets integrated with data sources according to example embodiments. Referring to FIG. 2B, the example code 216 identifies data importing criteria, such as data values, time intervals, and more specifically, transaction data for a particular transaction. Such data is imported to populate and update data sources on an ongoing basis to satisfy real-time data retrieval requirements.

A dataset may refer to a “table” of data with typed columns. Datasets may be populated from external data sources by defining the external sources via required credentials and defining the datasets that will populate themselves from these data sources. A first dataset may poll a table for new updates every specified time interval (i.e., one minute) and populate itself with new data. Another example dataset may define itself from a topic. New datasets may be derived from existing datasets by including declarative code to create a data pipeline.

FIG. 2C illustrates example code of a data pipeline according to example embodiments. Referring to FIG. 2C, the example code of data pipeline 218 may include creating a pipeline based on various inputs derived from existing datasets. The data identified from the existing datasets may be joined with new data values for new datasets.

The data pipeline may be considered a dataset that maintains transaction data. The pipeline may be based on more than one dataset, for example, one dataset may be streaming data (i.e., transaction data) and another dataset may be static. Datasets can be joined and/or aggregated together. Quick low-latency lookups may be performed on datasets using dataset keys. In one example, a key may be a user ID (UID). A dataset can also have multi-column keys. In this example, If the UID of a user is known, the dataset can be retrieved for a value of the rest of the columns.

Datasets may track a time related evolution of the data received and as the data evolves. Datasets can reference the time attributes when performing a data lookup. The transfer of data may be tagged by any field that is tagged with a timestamp field, such as ‘field (timestamp=True)’. The ability to track time data evolution enables the corresponding data management application to use the same code to generate both online and offline features.

A feature set is a collection of features, each with corresponding code (extractor) that permits the feature to be extracted. One example feature may be setup to compute a user's age using one or more defined datasets. One example may include a feature set with three (3) features, such as UID, country, and age. An extractor that is provided with the value of the feature UID can define the feature age. The extractor function may use one or more features to extract additional features based on how the extractor is coded. The extractors are able to perform a lookup of a user dataset to read the data computed by the datasets. The feature set may include one or more typed features with an extractor(s) that can extract those features. The feature extractors can recursively depend on other features whether in the same feature set or across other feature sets, and compute the output features.

Datasets are updated on the write path 110 as new data is received. The data migrates to the datasets and to additional datasets via data pipelines. The data migration may be occurring asynchronously and results in the data being stored in the datasets. Within the read path, the features are ‘read side’ attributes. The feature(s) is extracted while the received request is pending. The process may include an online feature serving request and/or an offline training data generation request. Features can recursively depend on other features and any existing bridge between the features represents lookup functionality associated with the dataset(s).

FIG. 2E illustrates example code of a synchronization call according to example embodiments. Referring to FIG. 2E, the synchronization call 226 may be used to identify data sources (i.e., servers) to import data to populate datasets and link feature sets. The synchronization of data is necessary to establish sources and intervals for updating the datasets.

In operation, the datasets and feature sets will exist in a data file (i.e., PYTHON file) in a codebase and any external servers will not have knowledge about those data elements until the servers are provisioned by issuing a synchronization call. In one example, a POST request is received and the dataset on the server is synchronized. The synchronization may be rejected if there is any error with any dataset or feature set, for example, if a dataset already exists with a particular name and/or the data is deficient. The number of datasets and feature sets may increase over time. The validation process can become increasingly complex due to schema compatibility validation across the whole existence of datasets/feature sets. Assuming the synchronization call succeeds, any datasets/feature sets that are not yet in existence will be created. Any datasets/feature sets that exist but are not provided in the synchronization call are deleted and the remaining entities are left unchanged.

Data sources may receive data from external data sources to populate the datasets. The data pipelines are created to derive new datasets from existing datasets. A feature may become a feature set when utilized in accordance with one or more datasets. Data sources 150 may be provided to the data and computational environment 100 webhook source (e.g., HTTP) and/or from external datastores. In one example, an object is created that identifies a connection with a database. A dataset may be identified and sourced from a database or a specific table. Once the object is in place, the datasets will update dynamically as data is updated in the data sources.

Once the environment management application obtains data from a source, the data needs to be parsed to extract and validate all the relevant fields (i.e., schema fields). The names of the fields in the dataset should match the schema of a received data string (i.e., JSON string). In this example, it is expected that the data table will have at least four columns (e.g., UID, city, country, and update_time) with appropriate data types. Other data columns in the table may be ignored. If received data does not match with the schema of the dataset, the data is discarded and not admitted to the dataset. Logs which identify the update times may be maintained and used to create alerts.

Various data types are matched from sourced data, including but not limited to: ‘int’, ‘float’, ‘str’, ‘bool’, and respectively matching with any integer types, float types, string types and boolean types identified. Security and data integrity may be maintained by using environment variables on local machines, defining credentials in a corresponding web console and referring to sources by their names in the code (PYTHON) definitions. Once the credentials reach the environment application servers, they are securely stored. Datasets refer to a table like data with typed columns. Datasets can be sourced from external datasets or derived from other datasets via data pipelines. Datasets may be written as classes. A dataset may include certain fields interchangeably referred to as columns with corresponding data types and unique names. Each field has a pre-specified datatype.

FIG. 2D illustrates example code of a dataset lookup and a feature set according to example embodiments. Referring to FIG. 2D, the dataset lookup code 222 may identify a data table or other defined component of a dataset and one or more data values to retrieve based on key fields.

Optional descriptors are used to provide non-typing related information about a field. Example field descriptors may include key fields which are those with field (key=True). The semantics are somewhat similar to those of a primary key in relational datasets. Datasets can be looked-up by providing the value of key fields. A dataset may have zero key fields (e.g., click streams) and in those cases, it is not possible to perform lookups on the dataset at all. Multiple key fields may be set on a dataset and in that case, all of those need to be provided while performing a lookup. A field with optional data types will not be a key field.

Timestamp fields may be those with ‘field (timestamp=True)’ set. Every dataset will have a timestamp field and this field will be a type ‘datetime’. Semantically, this field may represent ‘event time’ of a row. A timestamp field may be used to associate a particular state of a row with a timestamp. This permits the environment application to manage out of order events, perform time window aggregations, and compute point-in-time correct features for training data generation. If, for example, a dataset has a field of datetime type, it is assumed to be the timestamp field of the dataset without explicit annotation. However, if a dataset has multiple timestamp fields, one of those needs to be explicitly annotated to be the timestamp field.

Datasets can be annotated with useful meta information via metaflags, either at the dataset level or at the single field level. To ensure code ownership, the application requires every dataset to have an owner. A data pipeline is a function(s) defined on a dataset that describes how a dataset can be derived from one or more existing datasets. To create a dataset which represents information about transactions made by a user, the dataset may include a ‘classmethod’ since pipelines are generally classmethods. The pipeline may declare that it starts from user and transaction datasets. The pipeline function body is able to create other dataset objects and join multiple datasets and the resulting dataset is stored. A filter operation may be performed and the result is stored in another dataset with a different name. The pipelines are built out of a few general purpose operators including filter, transform, join, etc., which can be composed together to write a pipeline 134.

As soon as new data arrives as input from the data sources 150 to one or more of the datasets 112-119, the pipeline(s) 134 propagates the data downstream. The same approach is used whether the inputted data to the dataset(s) is continuously receiving data in realtime or if the data is received in a batch transfer manner. The pipeline code may be used for both realtime and batch data instances.

Referring again to FIG. 2D, the code example 224 demonstrates the attributes of a feature set of features, such as a class defined by UID, country, age, dob, etc. Those data values may be the basis of a query from a real-time data request to obtain user profile information. In the example of a credit card fraud detection procedure, a profile of a particular user may be requested to include certain features which may be used to make a decision or perform a prediction. Artificial intelligence and/or machine learning algorithms may be part of the data processing performed responsive to receiving the real-time request. In some embodiments, the features may provide data inputs and receive outputs from one or more machine learning models and/or machine learning networks. The features may interact directly with trained machine learning models and/or directly with machine learning or artificial intelligence services. The features may receive output from these models and/or services. A feature may receive inputs from one or more other features, data obtained from the created data environment, and/or other computed data values, and use this data as input to the machine learning algorithms, models, network, artificial intelligence service and/or machine learning services. In response to the input these machine learning and artificial intelligence services may provide an output to be further processed by the feature directly interacting with the machine learning and artificial intelligence services, and/or the output be later used by other features. In one example, data aggregation and data updating may be performed quickly for accurate predictions, such as whether a transaction is fraudulent or not fraudulent. By having datasets which are pre-configured and updated, the feature sets can be used to obtain accurate and updated data to perform a predictive analysis.

Feature sets may refer to a group of logically related features, where each feature (122-128) is backed by a code function (i.e., PYTHON scripted code) configured to extract the feature when called. A feature set is written as a class. A single application will generally have many feature sets. In one example, a feature set called ‘Movie’ may include two features ‘duration’ and ‘over_2 hrs’. Each feature has a corresponding type and is provided with a monotonically increasing ID that is unique within the feature set. This feature set has one extractor ‘my_extractor’ that when given the ‘duration’ feature, will extract the ‘over_2 hrs’ feature.

Extractors are stateless functions in a feature set. Each extractor accepts zero or more inputs and produces one or more features. In the above example, if the value of feature durations is known, ‘my_extractor’ can extract the value of ‘over_2 hrs’. When values of some features are desired, the data environment management application locates the extractors responsible for those features, verifies their inputs are available and runs their code to obtain the feature(s) values. Conceptually, an extractor could be considered a process that obtains a table of timestamped input features and produces a few output features for each row. Below is an example assuming three (3) input features (e.g., 123, hello, True, etc.) and two (2) output features (e.g., ?, ?):

| | Input | | Input | Output | Output |
|---|---|---|---|---|---|
| Timestamp | 1 | Input 2 | 3 | 1 | 2 |
| Jan 11, 2023, 11:00am | 123 | ‘hello’ | True | ? | ? |
| Jan 12, 2023, 8:30am | 456 | ‘world’ | True | ? | ? |
| Jan 13, 2023, 10:15am | 789 | ‘app.’ | False | ? | ? |

The output is intended to be the value of that feature as of the given timestamp while assuming other input feature values.

The extractor may be a classmethod so the first argument is ‘cls’. After that, the second argument is a series of timestamps (as shown above) and after that, one series is used for each input feature. The output is a named series or ‘dataframe’, depending on the number of output features of the same length as the input features. In general, a feature set can have zero or more extractors. An extractor can have zero or more inputs but requires at least one output. Input features of an extractor can belong to any number of feature sets but all output features must be from the same feature set as the extractor. For any feature, there can be at most one extractor where the feature appears in the output list. In this example, the extractor is looking up the value of a name given for the UID from the user dataset and returning that as a feature value. The extractor may explicitly declare that it depends on the user dataset. This approach permits the data environment management application to build an explicit lineage between features and the dependent datasets. The extractor is able to call a lookup (129) function on the dataset. This function also takes a series of timestamps as the first argument. Performing lookup operations on a dataset requires keys.

The data environment management application distinguishes between read path 120 and write path 110 computations since those two types of paths are different from a performance perspective. The write path 110 is throughput bound but does not have as much latency (delay) concerns and the read path 120 is sensitive to latency but often operates on smaller data batches. The write path 110 creates data and thus requires a significant amount of storage space, some of which may be wasted if the data is not read by a received request. The needed storage space may be complemented by a processing strategy of moving processing computations to the read path 120 which may repeat the same computation for each received request. Determining the computations to perform on the write path 110 vs. the read path 120 is an application specific decision and so the data environment application provides a way to control such decisions by precomputing some quantity on the write path 110 by maintaining the data computation in a data pipeline, or by performing the computation quickly by writing an extractor. In a majority of cases the computation would be moved to the write path 110 as part of a pipeline 134.

In one example, a feature that is used to perform a computation between a user and content embeddings where the number of users and content instances are large (e.g., 1 million) may be computationally intensive. Every pair of user/content utilized will require a computation and a large amount of storage and the results will not likely be read. In this case, it is optimal to lookup embeddings from datasets and perform the computation in an extractor.

In another example, if there is a model-based feature for a neural network model, such a feature could be placed on the write path 110 to save latency, however, the neural network may be operating on every row of a dataset, most of which may never be identified in production. In this case, depending on the CPU usage vs. latency trade-off, it may be optimal to keep the feature on the read path 120.

In another example, for features that depend on request specific properties (e.g., “is the transaction amount larger than user's average over the last 1 day”), the optimal option may be to perform a look-up of some partially precomputed information and perform such an operation on the read path 120.

In another example, for a temporal feature that represents a user's age, the values of this feature may update automatically with passing of time and so it is not possible to precompute this information on the write path 110. A more natural way to manage such data is to perform a look-up of a user's date of birth from a dataset and subtract that information from a current time.

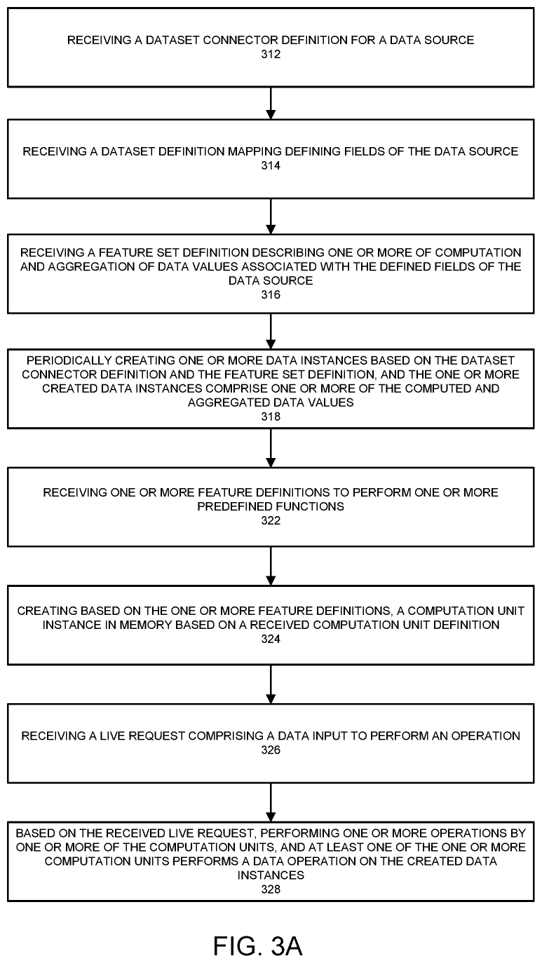

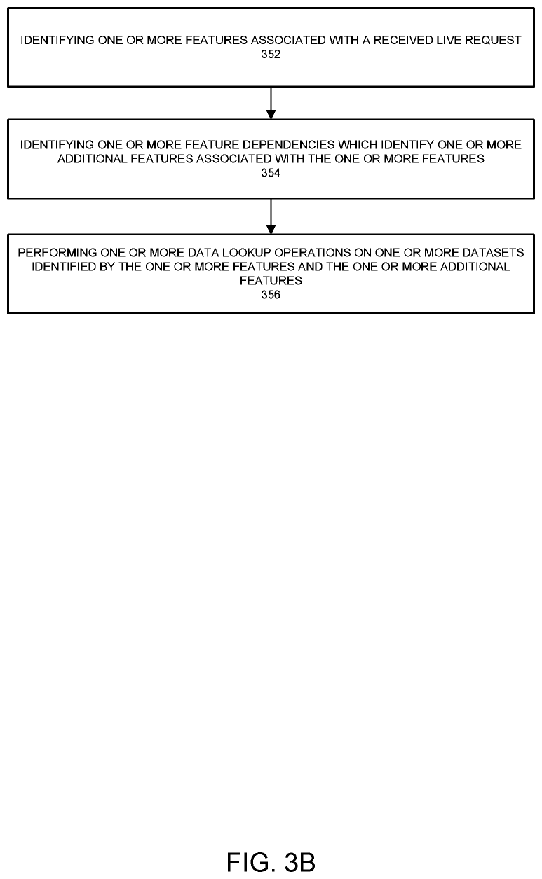

FIG. 3A illustrates a flow diagram of an example process according to example embodiments. Referring to FIG. 3A, the example process/method includes receiving a dataset connector definition for a data source 312, receiving a dataset definition mapping defining fields of the data source 314, and receiving a feature set definition describing one or more of computation and aggregation of data values associated with the defined fields of the data source 316. The write path 110 may include one or more datasets which are updated periodically based on data sources providing updated data sources. The process may also include periodically creating one or more data instances based on the dataset connector definition and the feature set definition, and the one or more created data instances may include one or more of the computed and aggregated data values 318, receiving one or more feature definitions to perform one or more predefined functions 322, creating based on the one or more feature definitions, a computation unit instance (i.e., program) in memory based on a received computation unit definition 324, receiving a real-time or live request (i.e., query) include a data input to perform an operation 326, and based on the received real-time request, performing one or more operations by one or more of the computation units, and at least one of the one or more computation units performs a data operation on the created data instances 328. The read path 120 may define the features and feature set necessary to satisfy the real-time request. The aggregated data from the write path 110 may be the source of information necessary to satisfy the request. Aggregated data values may include, but are not limited to, data values for a field that are summed, counted, averaged, totaled. Also, an aggregated data value may include a data value that is computed based on the evaluation of multiple fields of one or more data sources. The real-time request, for example, may be submitted from another system or service with data used by the endpoint 130.

The process may also include that the dataset connector includes a description of defining dataset inputs mapped to a dataset output, and the dataset connector includes a description of a period or frequency of when the extraction of the data extraction is performed. The process may further include receiving at one or more datasets one or more data lookups associated with one or more features of the feature set definition.

FIG. 3B illustrates another example process according to example embodiments. The process of FIG. 3B may include identifying one or more features associated with the received real-time request 352, identifying one or more feature dependencies which identify one or more additional features associated with the one or more features 354, and performing one or more data lookup operations on one or more datasets identified by the one or more features and the one or more additional features 356. This process of FIG. 3B may be a continuation of the process of FIG. 3A or an independent process performed by one or more processors.

The example processes may also include that the computation unit definition includes one or more descriptions. Performing one or more operations by the one or more computation units may include performing one or more data lookups on one more datasets to retrieve updated feature set data based on the feature set definition and the real-time request. The process may also include a dataset connector definition that includes a data file including one or more data fields which populate one or more data tables stored in one or more datasets. The one or more feature definitions identify one or more data values to be retrieved from one or more datasets and the feature set definition may identify an aggregated set of data values in one or more data sources to be created and provided responsive to the real-time request.

Although an exemplary embodiment of at least one of a system, method, and non-transitory computer readable media has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

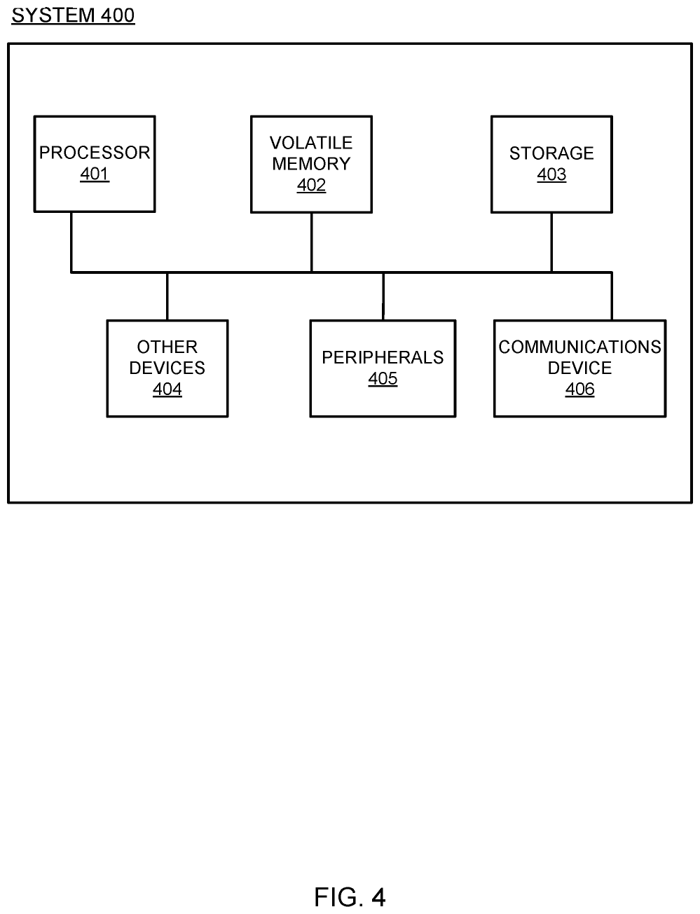

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

It will be appreciated that the present disclosure may include any one and up to all of the following examples.

### EXAMPLES

Example 1. A method comprising: receiving a dataset connector definition for a data source; receiving a dataset definition mapping defining fields of the data source; receiving a feature set definition describing one or more of computation and aggregation of data values associated with the defined fields of the data source; periodically creating one or more data instances based on the dataset connector definition and the feature set definition, wherein the one or more created data instances comprise one or more of the computed and aggregated data values; receiving one or more feature definitions to perform one or more predefined functions; creating based on the one or more feature definitions, a computation unit instance in memory based on a received computation unit definition; receiving a real-time request comprising a data input to perform an operation; and based on the received real-time request, performing one or more operations by one or more of the computation units, wherein at least one of the one or more computation units performs a data operation on the created data instances.

Example 2. The method of Example 1, wherein the dataset connector comprises a description of defining dataset inputs mapped to a dataset output.

Example 3. The method of any one of Examples 1-2, wherein the dataset connector comprises a description of a period of when the extraction of the data extraction is performed.

Example 4. The method of any one of Examples 1-3, comprising receiving at one or more datasets one or more data lookups associated with one or more features of the feature set definition.

Example 5. The method of any one of Examples 1-4, comprising identifying one or more features associated with the received real-time request; identifying one or more feature dependencies which identify one or more additional features associated with the one or more features; and performing one or more data lookup operations on one or more datasets identified by the one or more features and the one or more additional features.

Example 6. The method of any one of Examples 1-5, wherein the computation unit definition comprises one or more descriptions.

Example 7. The method of any one of any one of Examples 1-6, wherein the performing the one or more operations by the one or more computation units comprises performing one or more data lookups on one more datasets to retrieve updated feature set data based on the feature set definition and the real-time request.

Example 8. The method of any one of Examples 1-7, wherein the dataset connector definition comprises a data file including one or more data fields which populate one or more data tables stored in one or more datasets.

Example 9. The method of any one of Examples 1-8, wherein the one or more feature definitions identify one or more data values to be retrieved from one or more datasets.

Example 10. The method of any one of Examples 1-4, wherein the feature set definition identifies an aggregated set of data values in one or more data sources to be created and provided responsive to the real-time request.

Example 11. A system comprising one or more processors configured to perform: receiving a dataset connector definition for a data source; receiving a dataset definition mapping defining fields of the data source; receiving a feature set definition describing one or more of computation and aggregation of data values associated with the defined fields of the data source; periodically creating one or more data instances based on the dataset connector definition and the feature set definition, wherein the one or more created data instances comprise one or more of the computed and aggregated data values; receiving one or more feature definitions to perform one or more predefined functions; creating based on the one or more feature definitions, a computation unit instance in memory based on a received computation unit definition; receiving a real-time request comprising a data input to perform an operation; and based on the received real-time request, performing one or more operations by one or more of the computation units, wherein at least one of the one or more computation units performs a data operation on the created data instances.

Example 12. The system of Example 11, wherein the dataset connector comprises a description of defining dataset inputs mapped to a dataset output.

Example 13. The system of any one of Examples 11-12, wherein the dataset connector comprises a description of a period of when the extraction of the data extraction is performed.

Example 14. The system of any one of Examples 11-13, receiving at one or more datasets one or more data lookups associated with one or more features of the feature set definition.

Example 15. The system of any one of Examples 11-14, wherein the one or more processors is further configured to perform: identifying one or more features associated with the received real-time request; identifying one or more feature dependencies which identify one or more additional features associated with the one or more features; and performing one or more data lookup operations on one or more datasets identified by the one or more features and the one or more additional features.

Example 16. The system of any one of Examples 11-15, wherein the computation unit definition comprises one or more descriptions.

Example 17. The system of any one of Examples 11-16, wherein the performing the one or more operations by the one or more computation units comprises performing one or more data lookups on one more datasets to retrieve updated feature set data based on the feature set definition and the real-time request.

Example 18. The system of any one of Examples 11-17, wherein the dataset connector definition comprises a data file including one or more data fields which populate one or more data tables stored in one or more datasets.

Example 19. The system of any one of Examples 11-18, wherein the one or more feature definitions identify one or more data values to be retrieved from one or more datasets.

Example 20. A non-transitory computer readable storage medium configured to store instructions that when executed cause a processor to perform: receiving a dataset connector definition for a data source; receiving a dataset definition mapping defining fields of the data source; receiving a feature set definition describing one or more of computation and aggregation of data values associated with the defined fields of the data source; periodically creating one or more data instances based on the dataset connector definition and the feature set definition, wherein the one or more created data instances comprise one or more of the computed and aggregated data values; receiving one or more feature definitions to perform one or more predefined functions; creating based on the one or more feature definitions, a computation unit instance in memory based on a received computation unit definition; receiving a real-time request comprising a data input to perform an operation; and based on the received real-time request, performing one or more operations by one or more of the computation units, wherein at least one of the one or more computation units performs a data operation on the created data instances.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

It should be noted that some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field-programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed:

1. A method comprising:
receiving, via a server, a plurality of definition files, wherein receiving the definition files comprises:
receiving a dataset connector definition for a data source, the dataset connector definition including a description of a period or a frequency of when extraction of data from the data source is to be performed;
receiving a dataset definition mapping defining fields of the data source; and
receiving a feature set definition describing one or more of computation and aggregation of data values associated with the defined fields of the data source;
creating, by the server, a data environment by performing the operations of:
extracting data from the data source based on the extraction period or frequency according to the dataset connector definition; and
creating from the extracted data, one or more data instances based on the dataset connector definition and the feature set definition, wherein the one or more created data instances comprise one or more of the computed and aggregated data values, the data values being computed based on the evaluation of the defined fields of the data source, wherein the aggregated data values are values of the defined fields that are summed, counted, averaged or totaled;
creating, by the server, an execution environment for accessing the created data environment by performing the operations of:
receiving one or more feature definitions to perform one or more predefined extractor functions, wherein the one or more predefined extractor functions are described in a programming language code, wherein each of the extractor functions includes a defined input parameter and a defined output parameter, and wherein the extractor function includes one or more lookup functions that are defined to lookup, based on the defined input parameter, one of the aggregated data values from the created data instance and return a value as the defined output parameter that is based on an aggregated data value; and
creating based on the one or more feature definitions, one or more computation unit instances in memory based on a received computation unit definition by translating the programming language code of the one or more feature definitions into machine code that is stored in the memory for non-interpreted code operations;
receiving a real-time request comprising a data input to perform an operation; and
based on the received real-time request, performing one or more operations by one or more of the computation units created in the execution environment, wherein at least one of the one or more computation units performs a data operation according to the one or more predefined functions on the one or more data instances created in the data environment, and wherein the extractor provides the output based on one of the aggregated data values.

2. The method of claim 1, wherein the dataset connector comprises a description of defining dataset inputs mapped to a dataset output.

3. (canceled)

4. The method of claim 1, comprising receiving at one or more datasets one or more data lookups associated with one or more features of the feature set definition.

5. The method of claim 1, comprising
identifying one or more features associated with the received real-time request;
identifying one or more feature dependencies which identify one or more additional features associated with the one or more features; and
performing one or more data lookup operations on one or more datasets identified by the one or more features and the one or more additional features.

6. (canceled)

7. The method of claim 1, wherein the performing the one or more operations by the one or more computation units comprises performing one or more data lookups on one more datasets to retrieve updated feature set data based on the feature set definition and the real-time request.

8. The method of claim 1, wherein the dataset connector definition comprises a data file including one or more data fields which populate one or more data tables stored in one or more datasets.

9. The method of claim 1, wherein the one or more feature definitions identify one or more data values to be retrieved from one or more datasets.

10. The method of claim 1, wherein the feature set definition identifies an aggregated set of data values in one or more data sources to be created and provided responsive to the real-time request.

11. A system comprising one or more processors configured to perform the operations of:
receiving, via a server, a plurality of definition files, wherein receiving the definition files comprises:
receiving a dataset connector definition for a data source, the dataset connector definition including a description of a period or a frequency of when extraction of data from the data source is to be performed;
receiving a dataset definition mapping defining fields of the data source; and
receiving a feature set definition describing one or more of computation and aggregation of data values associated with the defined fields of the data source;
creating, by the server, a data environment by performing the operations of:
extracting data from the data source based on the extraction period or frequency according to the dataset connector definition; and
creating from the extracted data, one or more data instances based on the dataset connector definition and the feature set definition, wherein the one or more created data instances comprise one or more of the computed and aggregated data values, the data values being computed based on the evaluation of the defined fields of the data source, wherein the aggregated data values are values of the defined fields that are summed, counted, averaged or totaled;
creating, by the server, an execution environment for accessing the created data environment by performing the operations of:
receiving one or more feature definitions to perform one or more predefined extractor functions, wherein the one or more predefined extractor functions are described in a programming language code, wherein each of the extractor functions includes a defined input parameter and a defined output parameter, and wherein the extractor function includes one or more lookup functions that are defined to lookup, based on the defined input parameter, one of the aggregated data values from the created data instance and return a value as the defined output parameter that is based on an aggregated data value; and
creating based on the one or more feature definitions, one or more computation unit instances in memory based on a received computation unit definition by translating the programming language code of the one or more feature definitions into machine code that is stored in the memory for non-interpreted code operations;
receiving a real-time request comprising a data input to perform an operation; and
based on the received real-time request, performing one or more operations by one or more of the computation units created in the execution environment, wherein at least one of the one or more computation units performs a data operation according to the one or more predefined extractor functions on the one or more data instances created in the data environment, and wherein the extractor provides the output based on one of the aggregated data values.

12. The system of claim 11, wherein the dataset connector comprises a description of defining dataset inputs mapped to a dataset output.

13. (canceled)

14. The system of claim 11, receiving at one or more datasets one or more data lookups associated with one or more features of the feature set definition.

15. The system of claim 11, wherein the one or more processors is further configured to perform:
identifying one or more features associated with the received real-time request;
identifying one or more feature dependencies which identify one or more additional features associated with the one or more features; and
performing one or more data lookup operations on one or more datasets identified by the one or more features and the one or more additional features.

16. (canceled)

17. The system of claim 11, wherein the performing the one or more operations by the one or more computation units comprises performing one or more data lookups on one more datasets to retrieve updated feature set data based on the feature set definition and the real-time request.

18. The system of claim 11, wherein the dataset connector definition comprises a data file including one or more data fields which populate one or more data tables stored in one or more datasets.

19. The system of claim 11, wherein the one or more feature definitions identify one or more data values to be retrieved from one or more datasets.

20. A non-transitory computer readable storage medium configured to store instructions that when executed cause a processor to perform the operations of:
receiving, via a server, a plurality of definition files, wherein receiving the definition files comprises:
receiving a dataset connector definition for a data source, the dataset connector definition including a description of a period or a frequency of when extraction of data from the data source is to be performed;
receiving a dataset definition mapping defining fields of the data source; and
receiving a feature set definition describing one or more of computation and aggregation of data values associated with the defined fields of the data source;
creating, by the server, a data environment by performing the operations of:
extracting data from the data source based on the extraction period or frequency according to the dataset connector definition; and
creating from the extracted data, one or more data instances based on the dataset connector definition and the feature set definition, wherein the one or more created data instances comprise one or more of the computed and aggregated data values, the data values being computed based on the evaluation of the defined fields of the data source, wherein the aggregated data values are values of the defined fields that are summed, counted, averaged or totaled;
creating, by the server, an execution environment for accessing the data environment by performing the operations of:
receiving one or more feature definitions to perform one or more predefined extractor functions, wherein the one or more predefined extractor functions are described in a programming language code, wherein each of the extractor functions includes a defined input parameter and a defined output parameter, and wherein the extractor function includes one or more lookup functions that are defined to lookup, based on the defined input parameter, one of the aggregated data values from the created data instance and return a value as the defined output parameter that is based on an aggregated data value; and
creating based on the one or more feature definitions, one or more computation unit instances in memory based on a received computation unit definition by translating the programming language code of the one or more feature definitions into machine code that is stored in the memory for non-interpreted code operations;
receiving a real-time request comprising a data input to perform an operation; and
based on the received real-time request, performing one or more operations by one or more of the computation units created in the execution environment, wherein at least one of the one or more computation units performs a data operation according to the one or more predefined functions on the one or more data instances created in the data environment, and wherein the extractor provides the output based on one of the aggregated data values.

21. The method of claim 1, further comprising:
wherein each of the plurality of the definition files includes a version number to identify which of the definition files correspond to a system version; and
if any one of the definition files do not have the same version number of the other definition files, then generating error information, and not creating the data environment and/or the computational environment.

22. The method of claim 1, further comprising:
changing, by the server, the data environment and/or the computational environment based on receiving one or more modified or new definition files.

23. The method of claim 1, further comprising:
generating a data flow graph to evaluate data flow of the data source of the data instance;
determining the validity of the data flow graph; and
if the data flow graph is determined not to be valid, then generating error information, and not creating the data environment.

24. The method of claim 1, further comprising:
translating the plurality of feature definitions into an Abstract Syntax Tree (AST), the AST representing an abstract syntactic structure of text of the feature definitions.
